(19) United States
(12) Patent Application Publication
(10) Pub. No.: US 2015/0076303 A1
(43) Pub. Date: Mar. 19, 2015

(54) APPARATUS FOR SUPPORTING OBJECTS

(71) Applicant: Troy Ortman, Winamac, IN (US)

(72) Inventor: Troy Ortman, Winamac, IN (US)

(21) Appl. No.: 14/025,882

(22) Filed: Sep. 13, 2013

(51) Int. Cl. A01M 31/06; A44B 11/25; F16M 13/02

(52) U.S. Cl. CPC A01M 31/06; F16M 13/022; A44B 11/25
USPC 248/219.4

(57) ABSTRACT

A strap that secures to a tree or other object for supporting objects secured to the strap magnetically. Each object has an object strap for securing a magnet to it. The securing strap is attached to a tree then each individual object is secured magnetically to the securing strap.

### BACKGROUND OF THE INVENTION

Rattle horns for the attraction of male deer are not new to the art. However, most suffer from limitations that can interfere or even scare off deer while hunting. One such limitation is having the set of antlers tethered together. One such example of a limitation is disclosed in U.S. Pat. No. 4,610,641 entitled “Device for Attracting Deer and Elk”, issued to Allen on Sep. 9, 1986, showing a set of synthetic antlers that are connected together by a tether. The limitation arises when the antlers need to be quickly stowed. If the animal is within close proximity or even a relative short distance stowing the antlers can be noisy and spook the deer or elk. The hunter really needs to keep his eyes on the animal at all times.

It has been discovered that the present device allows to the hunter to stow the rattling antlers without looking at them by simply placing the powerful magnets within close proximity to one another wherein the magnets attract each other firmly securing the antlers to the tree.

In the United States Patent Publication U.S. 2004/0244152, entitled, “Belt-worn Article Carrier Apparatus”, in the name of Place, published on Dec. 9, 2004 is better in that the strap helps to keep the antlers separated from one another to limit unwanted interaction while in transport. However, it suffers from some of the same limitations. The user can attach the strap to a tree to secure the antlers during non-use, but when in use they must be buckled back together to secure them to the tree.

This maneuver requires the hunter to take his eyes off of the animal and the buckle makes a positive locking click when fully joined, making noise that can alert or spook the animal before the hunter has a chance to shoot it. The present invention will secure silently and therefore not alert the animal, giving the present invention superior utility over these and all other prior art tethers.

The present invention is capable of being fastened without the user removing his eyes form the prey. It also does this silently so as to not alarm the prey. These two aspects alone make the present invention superior in design and use giving it more utility than any other prior art device.

### THE INVENTION

The present invention is an apparatus for supporting objects. The apparatus comprises a strap that has two ends. The strap has a buckle fox attaching the two ends together. Each of the ends contains a magnet. The magnet is affixed to said scrap and when the magnetic ends are brought into close proximity they attach to one another supporting the objects in question.

### BRIEF DESCRIPTION OF THE DRAWINGS

FIG. 1A is a full view of the magnet attached to one rattling antler.

FIG. 1B is a full view of a magnet attached to a securing strap.

FIG. 2 is a view showing the securing strap attached to a tree and the rattling antler in close proximity.

FIG. 3 shows two rattling antlers magnetically attached to the securing strap.

### DETAILED DESCRIPTION OF THE DRAWINGS

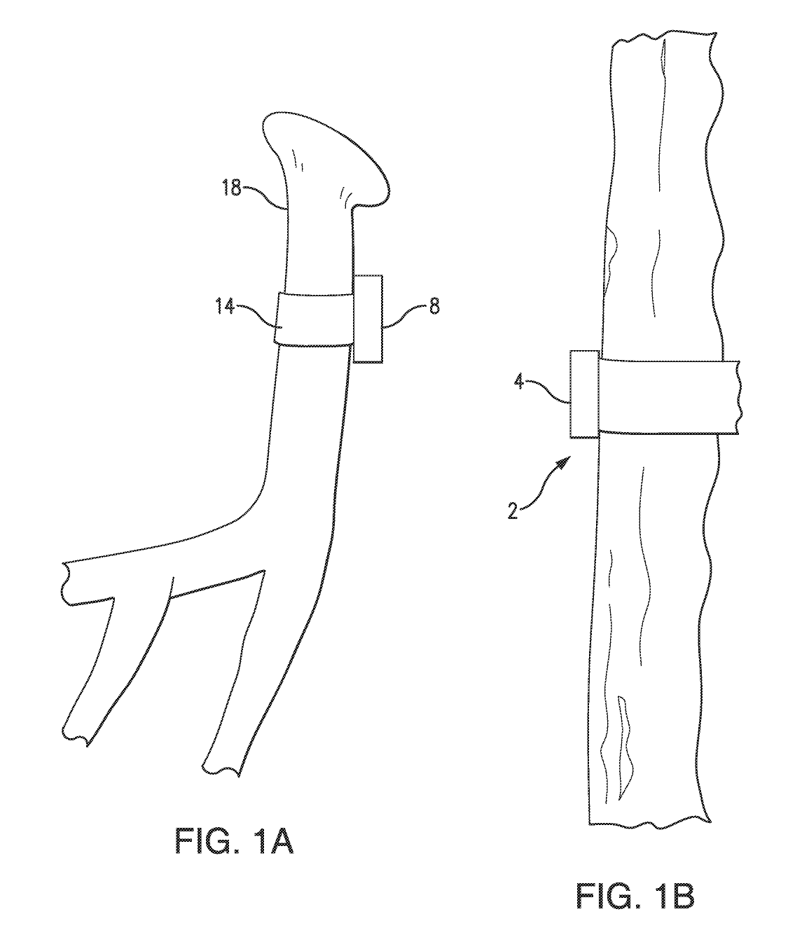

FIG. 1 shows a first magnet 8 attached to a first rattling antler 18 by a first object strap 14 and another magnet 4 attached to a securing strap 2. The securing strap 2 is adjustably attached to the tree 22 or other supporting object. Once the securing strap 2 is secured tightly to the tree 22 the antler 18 is affixed with the first object strap 14 and the magnet 8 they can be joined. Once this is done the antler 18 can be place in close proximity to the magnet 4 of the securing strap 2 and without having to look at the strap 2 or the antler 18 the magnets 8 and 4 draw one another together silently. This positively secures the antler 18 to the securing strap 2 without the user having to take his eyes off of the target and firmly securing the object to the securing strap 2.

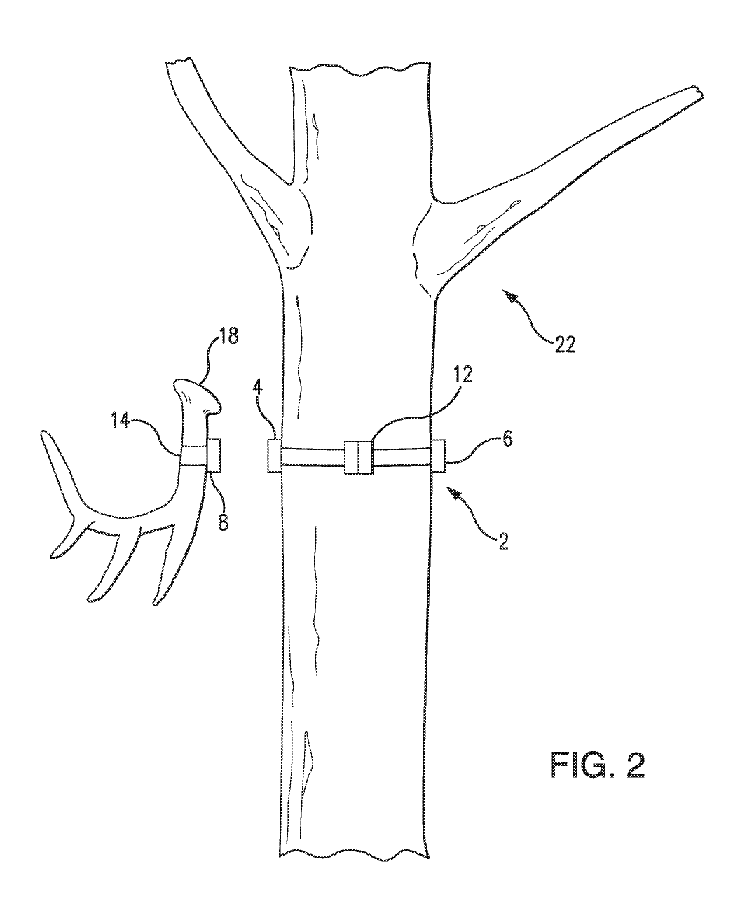

FIG. 2 shows the securing strap 2 attached to a tree 22 and the rattling antler 18 in close proximity. Once again the first object strap 14 is secured to the antler 18 and has the first object magnet 8 attached to the strap 14. The tree 22 or any other object capable of supporting the securing strap 2 is secured with its adjustable strap 2. The device can now support other objects such as antlers in this embodiment.

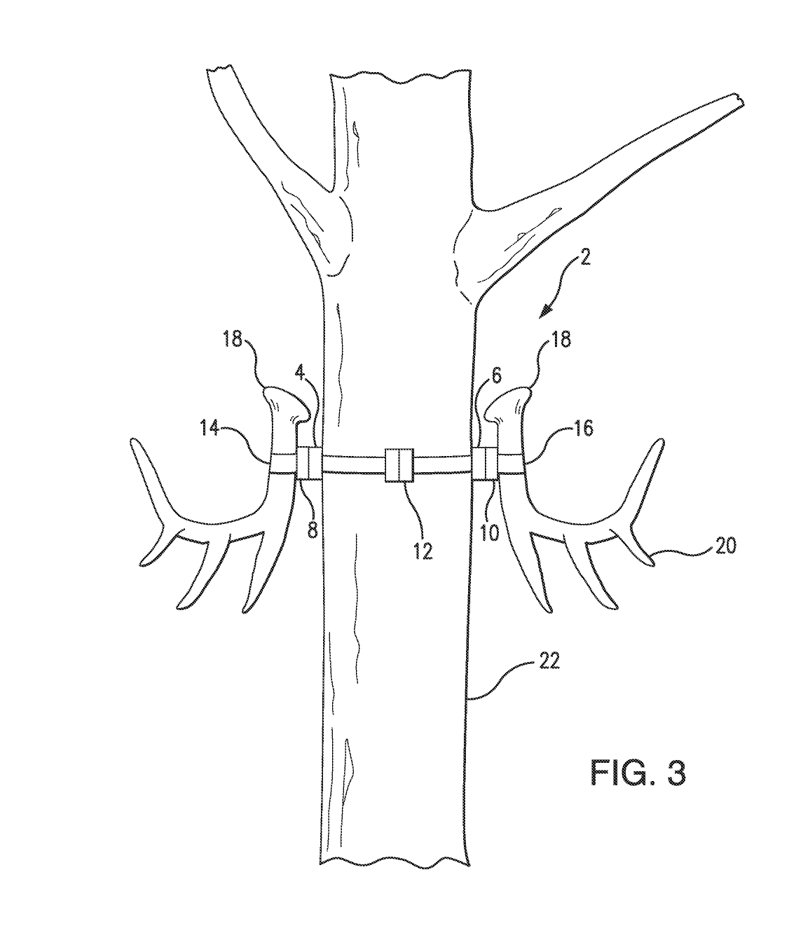

FIG. 3 shows both of the rattling antlers 18 and 20 magnetically attached to the securing strap 2. Here the strap 2 is adjustably secured to the tree 22 or as mentioned previously to another object that will support the strap 2 and items that are attached to the strap 2. The strap 2 has two magnets 4 and 6 that are spatially arranged to allow the supporting of these particular objects. Each of the objects to be supported by the strap 2 have a magnet 8 and 10 that are attached the object via an object strap 14 and 16. With the antlers 18 and 20 secured with the object straps 14 and 16 the user simply moves each object to a close proximity to the magnets 4 and 6 then the magnets 4 and 8, 6 and 10, are silently drawn together securing them.

The antlers 18 and 20 now remain secured until they are needed again. This also allows the hunter to not have to deal with the potential for bumping or kicking the antlers. It has been discovered that the present device creates a better, quieter hunting experience giving the present invention a greater utility ever all other prior art devices.

Another embodiment is represented in combination, the strap of and an object that have a metal tag attached thereto. The metal tag has a magnetic attachment capability. The combination of the object has magnetic attachment capability as a hunting object. In one embodiment the object is a deer antler.

In another embodiment the device is in combination, a strap and a first magnet that is affixed to the strap and a second magnet that is affixed to the strap, separated, and adjacent to the first magnet.

In another embodiment in combination, the strap of the first object has a metal tag attached thereto. The metal tag has a magnetic attachment capability.

Another embodiment in combination, the strap of the first object has a magnetic attachment capability that is a hunting object.

What is claimed is:

1. An apparatus for supporting objects, said apparatus comprising:
i. a strap having two ends, said strap having a buckle for attaching said two ends together;
ii. at least one magnet, each said magnet being affixed to said strap.

2. In combination, the strap of claim 1 and an object having a metal tag attached thereto, said metal tag having a magnetic attachment capability.

3. The combination as claimed in claim 2 wherein said object having magnetic attachment capability is a hunting object.

4. The combination as claimed in claim 3 wherein said object is a deer antler.

5. In combination, a strap as claimed in claim 1, a first magnet being affixed to said strap and a second magnet being affixed to said strap, separated, and adjacent to said first magnet.

6. In combination, the strap as claimed in claim 5 and a first object having a metal tag attached thereto, said metal tag having a magnetic attachment capability.

7. In combination, the strap as claimed in claim 6 wherein said first object having magnetic attachment capability is a hunting object.

8. In combination, the strap as claimed in claim 7 wherein said first hunting object is a deer antler.

9. In combination, the strap as claimed in claim 6 and a first object having a metal tag attached thereto and a second object having a metal tag attached thereto, wherein both metal tags have a magnetic attachment capability.

10. The combination as claimed in claim 9 wherein both of said objects are hunting objects.

11. The combination as claimed in claim 10 wherein both hunting objects are deer antlers.

12. The combination as claimed in claim 9 wherein both of said objects are hunting objects.
